(19) United States
(12) Patent Application Publication
(10) Pub. No.: US 2011/0175870 A1
(43) Pub. Date: Jul. 21, 2011

(54) DISPLAY PANEL SUBSTRATE, DISPLAY PANEL, AND METHOD FOR MANUFACTURING DISPLAY PANEL SUBSTRATE

(75) Inventor: Ryoh Ohue, Osaka (JP)

(73) Assignee: SHARP KABUSHIKI KAISHA, Osaka (JP)

(21) Appl. No.: 13/121,405

(22) PCT Filed: Oct. 19, 2009
(86) PCT No.: PCT/JP2009/068009

§ 371 Date: Mar. 28, 2011

(30) Foreign Application Priority Data
Oct. 20, 2008 (JP) 2008-269268

(51) Int. Cl. G06F 3/038

(52) U.S. Cl. 345/206

(57) ABSTRACT

Provided is a display panel substrate which facilitates positioning of an opposite substrate when the display panel substrate and the opposite substrate are bonded. The display panel substrate is provided with a transparent substrate (31), a plurality of switching elements (14) provided on the surface of one side of the transparent substrate (31), bus lines (11, 12) for transmitting predetermined signals to the plurality of switching elements (14), a first transparent material layer (33) formed so as to cover the plurality of switching elements (14) and the bus lines (11, 12), a colored layer (21) having a light collecting function stacked on the first transparent material layer (33), a black matrix (36) formed on the surface of the first transparent material layer (33) so as to cover the bus lines (11, 12), a second transparent material layer (34) formed so as to cover the colored layer (21) having the light collecting function and the black matrix (36), and a plurality of pixel electrodes (15) formed on the surface of the second transparent material layer (34).

### TECHNICAL FIELD

The present invention relates to a display panel substrate, a display panel, and a method for manufacturing a display panel substrate, and more specifically, the invention relates to a display panel substrate on which colored layers having a light collecting function are formed, to a display panel having such display panel substrate, and to the manufacturing method for such display panel substrate.

### BACKGROUND ART

A common active matrix liquid crystal display panel has a display panel substrate and an opposite substrate. A plurality of pixel electrodes, and switching elements driving each pixel electrode individually (thin film transistors, for example) are arranged in a matrix on the surface of one side of the display panel substrate. Furthermore, scanning lines (also referred to as gate bus lines) and data lines (also referred to as source bus lines), which transmit predetermined signals to respective switching elements, and the like are formed on the display panel substrate. Meanwhile, a grid-shaped black matrix is formed on the surface of one side of the opposite substrate. Colored layers of predetermined colors are formed in the regions defined by the black matrix (in other words, the region inside each grid).

A liquid crystal display panel commonly has a structure in which the display panel substrate and the opposite substrate are bonded facing each other with a certain minute space in between, and liquid crystal is filled in this space. When light is irradiated on the surface of one side of the liquid crystal display panel having such a structure, the irradiated light passes the colored layers and the liquid crystal layer. As a result, a visible image is displayed on the other surface of the liquid crystal display panel.

Light leakage and the like may occur and the display quality of a liquid crystal display panel can be lowered if the display panel substrate and the opposite substrate are positioned incorrectly. Specifically, for example, there is a liquid crystal display panel having a structure in which a pixel is divided into multiple regions, and the orientation of the liquid crystal is controlled per divided region. In such liquid crystal display panel, if the display panel substrate and the opposite substrate are positioned incorrectly (in other words, if the substrates are not bonded within a prescribed positioning tolerance), the borderline positions of the divided regions do not match between the pixel formed on the display panel substrate and the pixel formed on the opposite substrate. As a result, the orientation of the liquid crystal alignment becomes disorderly at the borderlines of the divided regions, and the problem of light leakage and the like may occur.

Therefore, it is necessary to position (bond) the display panel substrate and the opposite substrate to each other (bonded) with high accuracy in order to maintain and improve the display quality of a liquid crystal display panel with such a structure. However, a highly accurate alignment device is required when positioning (bonding) the display panel substrate and the opposite substrate opposite to each other, which results in the increase in equipment costs. Moreover, it is difficult to position the display panel substrate and the opposite substrate opposite to each other with an exact positional alignment.

Here, as described previously, bus lines such as scanning lines and data lines are formed on a display panel substrate. A black matrix is formed on the opposite substrate. As these scanning lines, data lines, and a black matrix are elements that do not pass light, a part of the light irradiated on the surface of one side of the liquid crystal display panel cannot pass a liquid crystal display panel due to those light-shielding elements. That is, a part of the irradiated light does not contribute to the image display, and is therefore wasted. In particular, the rate at which light incoming to the liquid crystal display panel surface from an oblique direction cannot pass the liquid crystal panel and therefore will be wasted is high. When a larger part of the incoming light is wasted, the brightness of a liquid crystal display panel becomes lower.

As a structure to waste less irradiated light and to improve the brightness of a liquid crystal display panel, a structure in which a micro lens is formed on the surface of a liquid crystal display panel is presented (see Patent Document 1). With such a structure, the light that had been blocked by light-shielding elements, such as scanning lines, data lines, and a black matrix, now can pass a liquid crystal display panel. Consequently, more light can pass a liquid crystal display panel, resulting in an improved brightness.

However, the structure disclosed in the aforementioned Patent Document 1 has the following problems. In the structure that a micro lens made of resin and the like is formed on the outer surface of a liquid crystal display panel, the surface of the micro lens is susceptible to scars and the like. Furthermore, if it contacts other members, the curvature of the micro lens may change. As a result, the micro lens may not collect light sufficiently and an improvement in the brightness may not occur. Attaching a polarizing plate may also be interfered as the outer surface of a micro lens is not flat.

### RELATED ART DOCUMENTS

### Patent Documents

Patent Document 1: Kokoku (Examined Patent Publication) No. 7-56547

### SUMMARY OF THE INVENTION

### Problems to be Solved by the Invention

Given the abovementioned situation, objects of the present invention are to provide a display panel substrate that facilitates positioning of an opposite substrate when the display panel substrate and the opposite substrate are bonded, a display panel having such a display panel substrate, and a manufacturing method for such a display panel substrate; provide a display panel substrate that does not require the precise positioning of an opposite substrate when the display panel substrate and the opposite substrate are bonded, a display panel having such a display panel substrate, and the manufacturing method for such a display panel substrate; and provide a display panel substrate in which the incoming light is efficiently utilized, a display panel having such a display panel substrate, and a manufacturing method for such a display panel substrate.

### Means for Solving the Problems

To solve the aforementioned problems, the present invention provides a display panel substrate including a transparent substrate, wherein a plurality of pixel electrodes and switching elements to respectively drive the plurality of pixel electrodes are formed on one surface of the transparent substrate, and wherein colored layers having a light collecting function are also formed between the aforementioned transparent substrate and the aforementioned pixel electrodes.

It is preferred to have a structure in which a first transparent material layer and a second transparent material layer are formed to be laminated on one another between the aforementioned transparent substrate and the aforementioned pixel electrodes, and the aforementioned colored layers having the light collecting function are formed between the aforementioned first transparent material layer and the aforementioned second transparent material layer.

Furthermore, it is preferred to have a structure in which a black matrix is formed between the adjacent colored layers.

It is preferred to have a structure in which the aforementioned colored layer having the light collecting function gains the light collecting function by having a curved surface for at least the surface facing the first transparent material layer or the surface facing the second transparent material layer.

It is preferred to have a structure in which the aforementioned colored layers having the light collecting function are made of a photosensitive resin material colored in an appropriate color.

The present invention includes a transparent substrate; a plurality of switching elements formed on a one surface of the transparent substrate; bus lines that transmit predetermined signals to the plurality of switching elements; a first transparent material layer formed so as to cover the aforementioned plurality of switching elements and the aforementioned bus lines; a colored layer having the light collecting function stacked on the first transparent material layer; a black matrix formed on the surface of the aforementioned first transparent material layer so as to cover the aforementioned bus lines; a second transparent material layer formed so as to cover the aforementioned colored layer having the light collecting function and the aforementioned black matrix; and a plurality of pixel electrodes formed on a surface of the second transparent material layer and driven by the aforementioned switching elements individually.

For the aforementioned colored layers having the light collecting function, it is preferred that at least the surface contacting the first transparent material layer or the second transparent material layer is formed in a curved shape.

Additionally, it is preferred to have a structure in which the aforementioned colored layers having the light collecting function are made of a photosensitive resin material colored in a predetermined color.

The present invention includes any one of the aforementioned display panel substrates and the opposite substrate, the aforementioned display panel substrate and the aforementioned opposite substrate are bonded with a certain minute space in between, and liquid crystals are filled in the space between the aforementioned display panel substrate and the aforementioned opposite substrate.

The present invention includes the steps of forming bus lines and switching elements on a one surface of a transparent substrate; forming a first transparent material layer to cover the aforementioned bus lines and switching elements; forming colored layers on the surface of the first transparent material layer, providing a light collecting function on the aforementioned colored layers by forming a surface of one side of the aforementioned colored layer in a curved shape; forming a second transparent material layer to cover the aforementioned colored layers; and forming a plurality of pixel electrodes on the surface of the aforementioned second transparent material layer.

Here, in the step of providing the light collecting function on the aforementioned colored layers by forming the surface of one side of the aforementioned colored layer in a curved shape, it is preferred to use a method that the aforementioned colored layers are softened by heating, and the surface of the one side is curved by the surface tension of the aforementioned softened colored layer.

A step to form a black matrix between each of the aforementioned colored layers may be added after the step of providing the light collecting function on the aforementioned colored layer by forming the surface of one side of the aforementioned colored layer in a curved shape, and before the step of forming the second transparent material layer to cover the aforementioned colored layers.

### EFFECTS OF THE INVENTION

According to the present invention, a black matrix and colored layers are formed on the display panel substrate on which switching elements are formed, not on the opposite substrate. Therefore, positioning of the black matrix and the colored layers can be performed along with the positioning of other elements formed on the display panel substrate (such as switching elements, various bus lines, pixel electrodes) all at once. Consequently, it becomes easier to maintain and improve the accuracy of the positioning of the black matrix and the colored layers.

Furthermore, according to the present invention, because the black matrix and the colored layers are formed not on the opposite substrate, but on the substrate where elements such as switching elements are formed, there is no need to form elements on the opposite substrate that require positioning upon coupling the substrates. As a result, the positioning becomes easier when the display panel substrate and the opposite substrate are bonded, or highly accurate positioning need not be performed. Because a device for highly accurate positioning is not required in the step of coupling the display panel substrate and the opposite substrate, reduction in the equipment cost can be achieved. The manufacturing cost of a display panel can also be reduced because the positioning step can be removed.

Additionally, the light incoming to the display panel can be efficiently utilized as the display panel substrate has a light collecting means, and therefore, the brightness of the display panel can be improved.

### BRIEF DESCRIPTION OF THE DRAWINGS

FIG. 1 is a plain view of a pixel formed on a display panel substrate of a preferred embodiment of the present invention.

FIG. 2 is a cross-sectional view along the line A-A of FIG. 1, showing a cross-sectional structure of the pixel formed on the display panel substrate of a preferred embodiment of the present invention.

FIG. 3 is a schematic cross-sectional view showing respective steps of manufacturing the display panel substrate of a preferred embodiment of the present invention.

FIG. 4 is a schematic cross-sectional view showing respective steps of manufacturing the display panel substrate of a preferred embodiment of the present invention.

FIG. 5 is a schematic cross-sectional view showing respective steps of manufacturing the display panel substrate of a preferred embodiment of the present invention.

FIG. 6 is a schematic cross-sectional view showing respective steps of manufacturing the display panel substrate of a preferred embodiment of the present invention.

FIG. 7 is a schematic cross-sectional view showing respective steps of manufacturing the display panel substrate of a preferred embodiment of the present invention.

FIG. 8 is a schematic cross-sectional view showing a cross-sectional structure of an opposite substrate.

FIG. 9 is a schematic cross-sectional view showing a cross-sectional structure of a display panel of a preferred embodiment of the present invention.

### DETAILED DESCRIPTION OF EMBODIMENTS

Preferred embodiments of the present invention will be described in detail with references to the figures as follows.

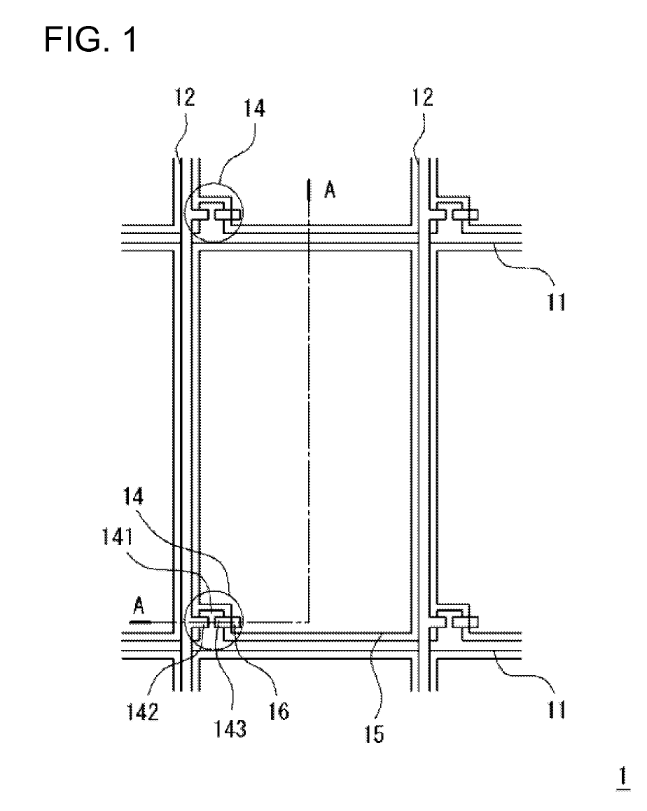

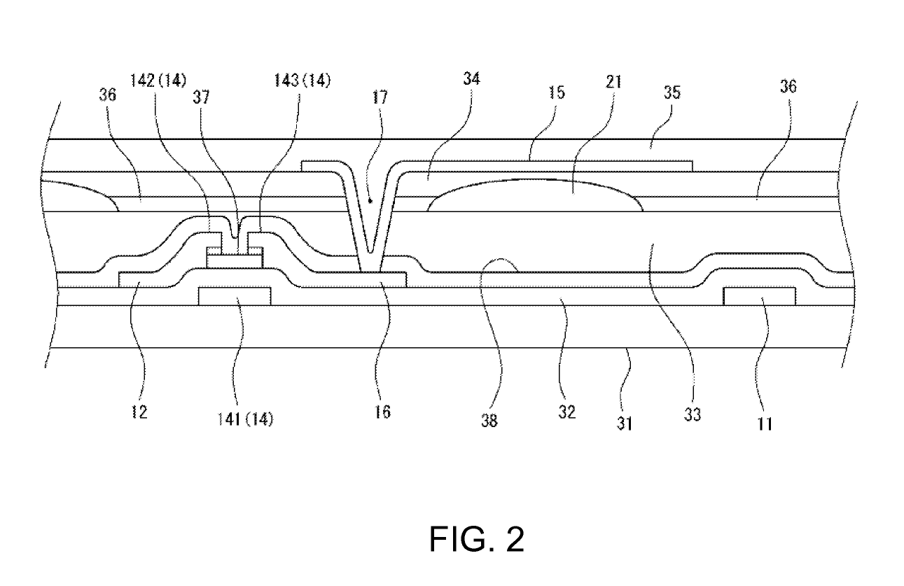

FIG. 1 is a schematic plain view showing a structure of a pixel formed on a display panel substrate of a preferred embodiment of the present invention. FIG. 2 is a schematic cross-sectional view along the line A-A of FIG. 1, showing the cross-sectional structure of the pixel formed on the display panel substrate of a preferred embodiment of the present invention.

As shown in FIG. 1, a plurality of scanning lines 11 (also referred to as gate bus lines) are formed substantially in parallel with each other with a certain distance in between on the display panel substrate 1 of a preferred embodiment of the present invention. In the direction perpendicular to the scanning lines 11, a plurality of data lines 12 (also referred to as source bus lines) are formed substantially in parallel with each other with a certain distance in between.

A switching element 14 (for example, Thin Film Transistor (TFT)) is formed near the intersection of each scanning line 11 and data line 12. This switching element 14 includes a gate electrode 141, a source electrode 142, and a drain electrode 143.

A plurality of pixel electrodes 15 (also referred to as transparent electrodes) formed in a substantially square-shape are also arranged in a matrix on the display panel substrate 1. This pixel electrode 15 is electrically connected to the drain electrode 143 of the switching element 14 via a drain line 16.

As shown in FIG. 2, scanning lines 11, data lines 12, drain lines 16, switching elements 14, and the pixel electrodes 15 are formed in a laminating manner on one surface of a transparent substrate 31 made of a glass and the like. More specifically, the display panel substrate 1 of a preferred embodiment of the present invention has a cross-sectional structure, as follows. Here, for simplicity, the upper part of FIG. 2 is referred to as “the upper part” or “the upper layer side,” and the lower part of FIG. 2 is referred to as “the lower part” or “the lower layer side” of the display panel substrate 1 of a preferred embodiment of the present invention.

The scanning lines 11 are formed on the surface of the transparent substrate 31. Then, a gate electrode 141 of a switching element 14 is formed integrally with the scanning lines 11 by using the same material as the scanning lines 11. A gate insulation film 32 is formed over the scanning lines 11 and the gate electrode 141 of the switching elements 14. Consequently, the scanning lines 11 and the gate electrodes 141 of the switching elements 14 are covered by the gate insulation film 32. A semiconductor film 37 is formed at an appropriate position (in particular, the position where it overlaps the gate electrode 141 of the switching element 14) on the upper surface of the gate insulation film 32. Furthermore, the data lines 12 and the drain lines 16 are formed on the upper surface of the gate insulation film 32. Here, a source electrode 142 of the switching elements 14 is formed integrally with the data lines 12 by using the same material as the data lines 12. A drain electrode 143 is also formed integrally with the drain lines 16 by using the same material as the drain lines 16.

A passivation film 38 and a first transparent material layer 33 are formed on the upper layer side of the aforementioned various elements. The passivation film 38 is made of silicon nitride or the like. The first transparent material layer 33 is, for example, made of an acrylic resin or fluorinated resin.

Colored layers 21 having a light collecting function are formed on the upper surface of the first transparent material layer 33. The colored layer 21 having the light collecting function is made of a photosensitive resin material in which pigments or dye of a certain color (specifically, either red, blue or green) is mixed. This colored layer 21 having the light collecting function has a curved shaped upper surface projecting toward the upper layer side. The colored layer 21 having the light collecting function overall has a cross-section similar to a convex lens because the upper surface is in a curved shape projecting toward the upper layer side. Therefore, the colored layer 21 having the light collecting function has a light collecting function similar to that of a convex lens.

A black matrix 36 is formed in between each of the adjacent colored layers 21 having the light collecting function so as to overlap the scanning lines 11 and the data lines 12. The black matrix 36 is made of a photosensitive resin material in which black pigments or dye are mixed.

A second transparent material layer 34 is formed on the upper layer side of the colored layers 21 having the light collecting function and the black matrix 36. The upper surface of the second transparent material layer 34 is formed substantially flat. This second transparent material layer 34 is made of an acrylic resin or fluorinated resin, for example.

A pixel electrode 15 is formed on the upper surface of the second transparent material layer 34. The pixel electrode 15 is made of Indium Tin Oxide (ITO) or the like, for example. The pixel electrode 15 is electrically connected to the drain lines 16 through an opening 17 (a contact hole), which is formed to penetrate through the first transparent material layer 33, the second transparent material layer 34, the colored layers 21 having the light collecting function, and the passivation film 38.

A protective film 35 is formed on the upper surfaces of the second transparent material layer 34 and the pixel electrode 15. This protective film 35 is made of silicon nitride or the like, for example.

The refractive index of the colored layer 21 having the light collecting function is larger than that of the first transparent material layer 33 and the second transparent material layer 34. For example, when the first transparent material layer 33 and the second transparent material layer 34 are made of an acrylic resin (the refractive index is approximately 1.5) or fluorinated resin (the refractive index is approximately 1.4), a polyimide resin (the refractive index is approximately 1.7), epoxy resin (the refractive index is approximately 1.55 to 1.61), or the like can be used for the colored layer 21 having the light collecting function.

As described above, the display panel substrate 1 of a preferred embodiment of the present invention has the colored layers 21 having the light collecting function formed in between the transparent substrate 31 and the transparent electrode (pixel electrode) 15. With such a structure, the colored layers 21 having the light collecting function between the first transparent material layer 33 and the second transparent material layer 34 function as a micro lens having a similar function to that of a convex lens. Therefore, the light pathway is defined by the curvature radius of the upper surface of the colored layer 21 having the light collecting function, the refractive index ratio of the first transparent material layer 33 and the colored layer 21 having the light collecting function, and the refractive index of the second transparent material layer 34 and the colored layer 21 having the light collecting function.

The black matrix 36 and the colored layers 21 having the light collecting function are formed on the display panel substrate 1 where the switching elements 14 are formed, not on the opposite substrate. Therefore, the positioning of the black matrix 36 and the colored layers 21 having the light collecting function can be performed along with the positioning of other elements to be formed on the display panel substrate 1 (such as switching elements 14, scanning lines 11, data lines 12, pixel electrodes 15) all at once. As a result, it becomes easier to maintain and improve the accuracy of the positioning of the black matrix 36 and the colored layers 21 having the light collecting function.

The improvement in brightness can be achieved for the display panel having the display panel substrate 1 of a preferred embodiment of the present invention, because the colored layers 21 of the display panel substrate 1 have the light collecting function. The surface of the colored layers 21 having the light collecting function cannot also be scarred because the colored layers 21 having the light collecting function are formed inside the display panel substrate 1. Additionally, the surface curvature of the colored layers 21 having the light collecting function cannot be altered, because the colored layers 21 having the light collecting function do not contact other members. These aspects facilitate the colored layers 21 having the light collecting function to exhibit the light collecting function sufficiently, resulting in the improved brightness for the display panel having the display panel substrate 1. Additionally, the light collecting function is not formed on the bottom surface of the display panel substrate 1 (in other words, the surface that becomes the outer surface when bonded with the opposite substrate), therefore it will not interfere with the bonding of a polarizing plate and the like.

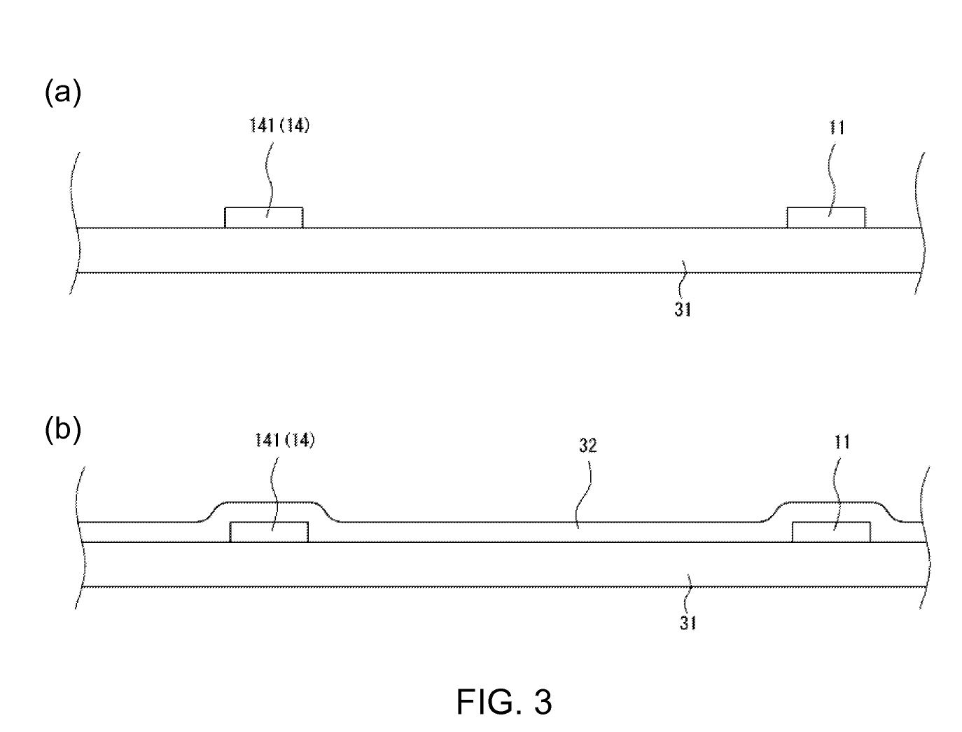

A manufacturing method for the display panel substrate 1 of a preferred embodiment of the present invention is described as follows. FIG. 3 through FIG. 5 are schematic cross-sectional views, showing respective steps of the manufacturing method for the display panel substrate 1 according to a preferred embodiment of the present invention. These figures correspond to the cross-sectional view along the line A-A of FIG. 1.

First of all, as shown in FIG. 3(a), a scanning line 11 and a gate electrode 141 of a switching element 14 are formed on one surface of a transparent substrate 31, which is made of a glass or the like. Specifically, a single layered or multiple layered conductor film made of chromium, tungsten, molybdenum, aluminum or the like (hereinafter referred to as “first conductor film”) is formed on one surface of the transparent substrate 31. Methods such as various known sputtering methods can be used to form this first conductor film. The thickness of the first conductor film is not particularly limited, but the film thickness of approximately 300 nm can be used. Then, the formed first conductor film is patterned into a shape of the scanning lines 11 and the gate electrode 141 of the switching elements 14 and the like. Various known wet etching methods can be used for this patterning of the first conductor film. For example, a wet etching method using (NH₄)₂[Ce(NH₃)₆]+HNO₃+H₂O liquid can be used when the first conductor film is made of chrominum.

Next, as shown in FIG. 3 (b), the gate insulation film 32 is formed on the surface of the transparent substrate 31, which has undergone the aforementioned steps. SiNx (silicon nitride) of an approximate thickness of 300 nm or the like can be used for the gate insulation film 32. The plasma CVD method can be used to form the gate insulation film 32. As shown in FIG. 3 (b), the scanning line 11 and the gate electrode 141 of switching element 14 are covered by the gate insulation film 32 once the gate insulation film 32 is formed.

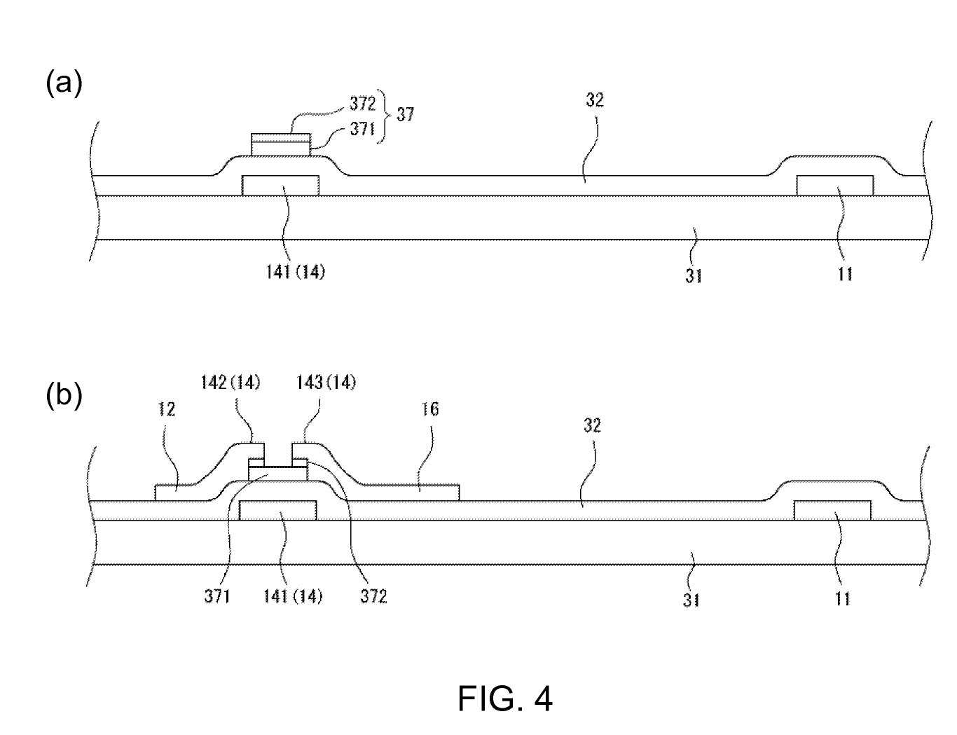

Next, as shown in FIG. 4 (a), a semiconductor film 37 of a predetermined shape is formed at a predetermined position on the surface of the gate insulation film 32. More specifically, this semiconductor film 37 is at a position that overlaps the gate electrode 141 of the switching element 14 through the gate insulation film 32. This semiconductor film 37 has a double layer structure of a first sub semiconductor film 371 and a second sub semiconductor film 372. Amorphous silicon with an approximate thickness of 100 nm or the like can be used for the first sub semiconductor film 371. n+ type amorphous silicon with the approximate thickness of 20 nm or the like can be used for the second sub semiconductor film 372.

The first sub semiconductor film 371 functions as an etching stopper layer in the step of forming the data lines 12, the drain lines 16, and the like by etching. The second sub semiconductor film 372 is to facilitate an ohmic contact with the source electrode 142 and the drain electrode 143 of the switching element 14, which are formed in a later step.

This semiconductor film 37 (the first sub semiconductor film 371 and the second sub semiconductor film 372) can be formed by means of a plasma CVD method and a photolithography process. That is, the material of the semiconductor film 37 (the first sub semiconductor film 371 and the second sub semiconductor film 372) is deposited by the plasma CVD method on one surface of the transparent substrate 31, which has undergone the aforementioned steps. Then, the formed semiconductor film 37 (the first sub semiconductor film 371 and the second sub semiconductor film 372) is patterned into a certain shape by photolithography or the like.

Specifically, a photoresist material layer is formed on the surface of the thus created semiconductor film 37. A spin coater or the like can be used for forming the photoresist material layer. Then, a development process is carried out after an exposure treatment is performed on the thus formed photoresist material layer by using a photomask. As a result, a photoresist material layer with a predetermined pattern is left on the surface of the semiconductor film 37 in a display region.

Then, the semiconductor film 37 is patterned by using the patterned photoresist material layer as a mask. A process such as wet etching using an HF+HNO₃ solution or dry etching using Cl₂ and SF₆ gases can be used for this patterning. As a result, the semiconductor film 37 (the first sub semiconductor film 371 and the second sub semiconductor film 372) of a predetermined shape is formed over the gate electrode 141 with the gate insulation film 32 in between.

Next, as shown in FIG. 4 (b), data lines 12, drain lines 16, the source electrodes 142 and the drain electrodes 143 of the switching elements 14 are formed. Specifically, a conductor film, which is the material for the data lines 12, the drain lines 16, the source electrodes 142 and the drain electrodes 143 of the switching elements 142 (this conductor film is referred to as the “second conductor film”), is formed on the one surface of the transparent substrate 31, which has undergone the aforementioned steps. Then, the formed second conductor film is patterned into a predetermined shape.

The second conductor film has a multiple-layer structure of two or more layered made of titanium, aluminum, chrome, molybdenum and the like. For example, the second conductor film has a double layer structure made up of a first sub conductor film that is close to the transparent substrate 31 and a second sub conductor film that is close to the pixel electrodes. Titanium or the like can be used for the first sub conductor film. Aluminum or the like can be used for the second sub conductor film.

A sputtering method or the like can be used to form the second conductor film. Dry etching using Cl₂ and BCl₃ gases or wet etching using phosphoric acid, acetic acid, and nitric acid can be used to pattern the second conductor film. The data lines 12, the drain lines 16, the source electrodes 142 and drain electrodes 143 of the switching elements 14 are formed by this patterning. During this patterning, the second sub semiconductor film 372 is also etched using the first sub semiconductor film 371 as an etching stopper layer.

As shown in FIG. 4 (b), after the abovementioned steps, the switching elements 14 (that is, the gate electrodes 141, the source electrodes 142 and the drain electrodes 143), the data lines 12, the scanning lines 11, and the drain lines 16 are formed on the one surface of the transparent substrate 31.

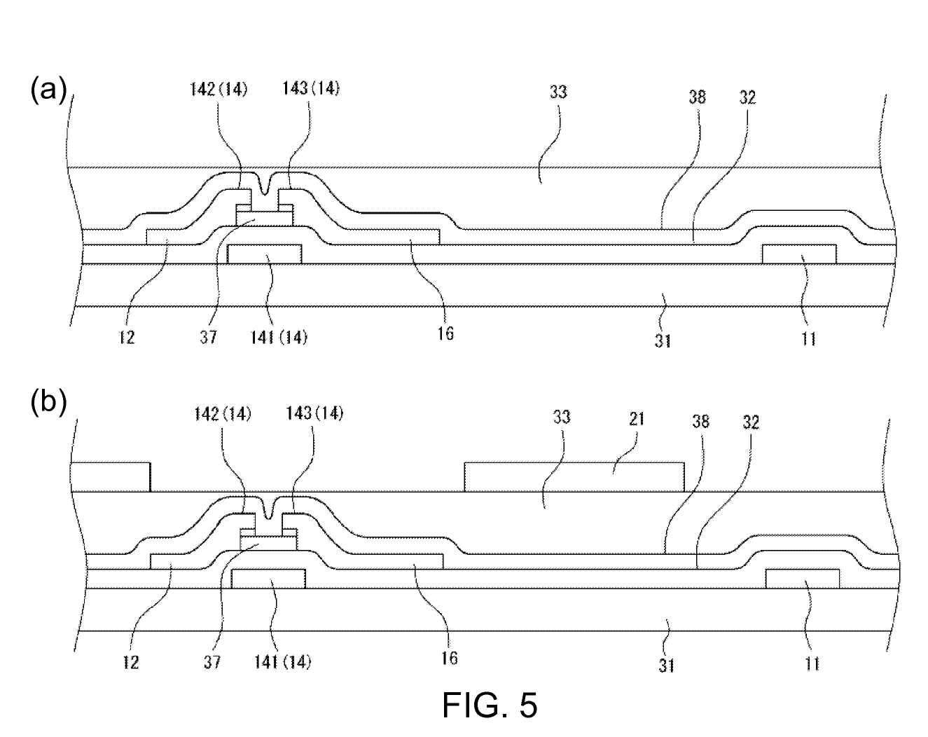

Next, as shown in FIG. 5 (a), a passivation film 38 and a first transparent material layer 33 are formed on the one surface of the transparent substrate 31, which has undergone the aforementioned steps. SiNx (silicon nitride) with an approximate thickness of 300 nm can be used for the passivation film 38. A plasma CVD method or the like can be used for forming the passivation film 38. Then, the first transparent material layer 33 is formed on the surface of the thus formed passivation film 38. Acrylic resin or fluorinated resin can be used for the first transparent material layer 33.

The next step, as shown in FIG. 5 (b), is to form a colored layer on the surface of the first transparent material layer 33. Specifically, coloring photosensitive material (a solution in which pigments of a certain color is dispersed in a photosensitive material) is applied on the surface of the first transparent material layer 33. Then, the applied coloring photosensitive material is formed into a predetermined pattern by photolithography or the like. This process is performed for red, green and blue individually. As a result, the colored layers 21 of respective colors are obtained.

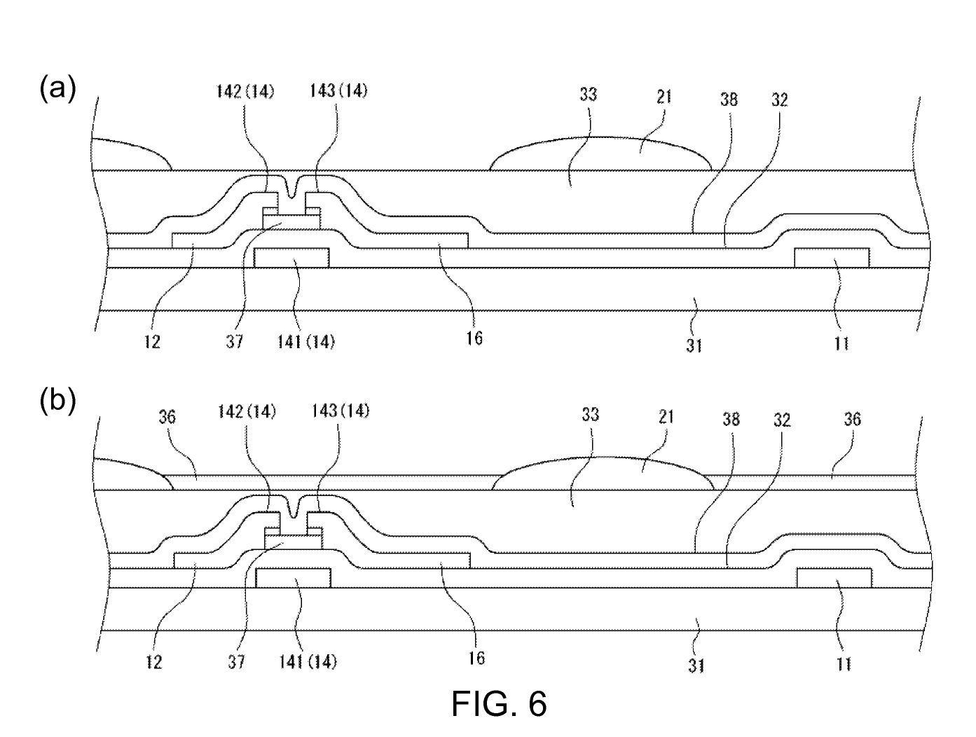

Then, as shown in FIG. 6 (a), the colored layers 21 formed on the surface of the first transparent material layer 33 are heat-treated (also referred to as “reflow process”). The colored layers 21 become soft and change to viscous liquid when they are heat-treated, and the upper surface changes its shape to substantially curved-shape by the surface tension. As a result, the colored layers 21 exhibit a shape of a convex lens projecting toward the upper direction in a circular arc-shape, building the light collecting function on the colored layers 21. Furthermore, the curvature radius of the upper surface of the colored layers 21 can be set as needed by adjusting the thickness of the coloring photosensitive material to be applied, the temperature and time of the heat-treatment, and the viscosity of the coloring photosensitive material during the heat-treatment.

Next, as shown in FIG. 6 (b), a black matrix 36 is formed between the respective colored layers 21 so as to cover the scanning lines 11 and the data lines 12. Specifically, a BM resist (a photosensitive resin composition including black coloring agent) is applied to the surface of the transparent substrate 31, which has undergone the aforementioned steps. Then, the applied BM resist is formed into a predetermined pattern by a photolithography or the like. As a result, the black matrix 36 of a predetermined pattern is obtained.

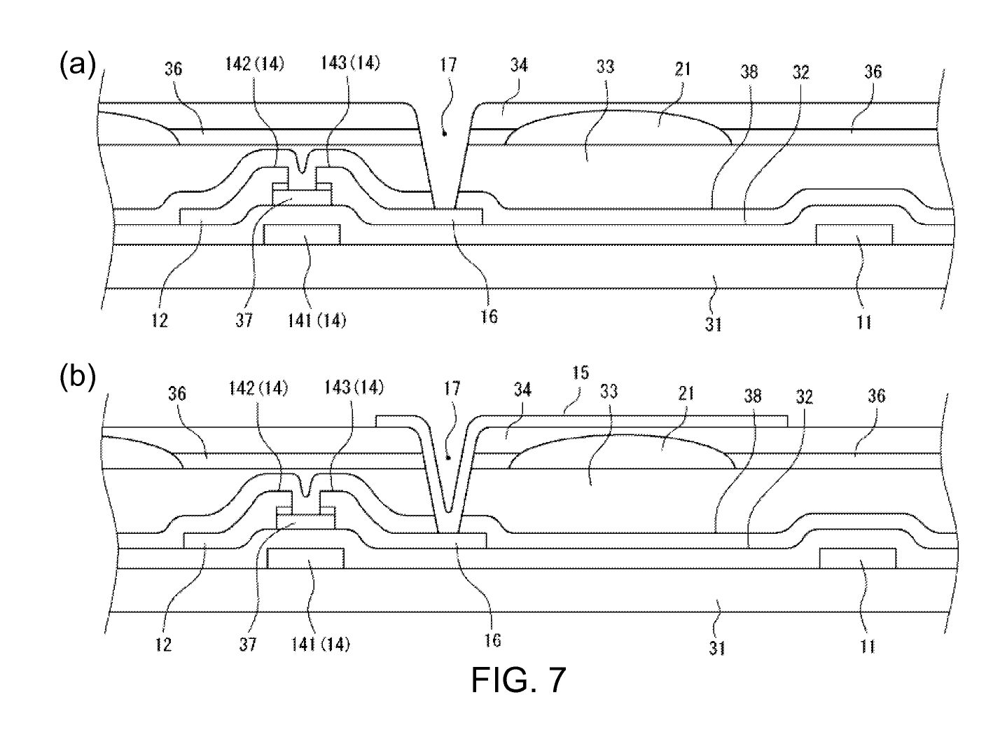

Next, as shown in FIG. 7 (a), a second transparent material layer 34 is formed on the surface of the colored layers 21 having the light collecting function and the black matrix 36. An acrylic resin, fluorinated resin or the like can be used for the second transparent material layer 34. An opening 17 (in other words, a contact hole) to electrically connect the pixel electrode 15 and the drain line 16 is formed in the first transparent material layer 33 and the second transparent material layer 34. A photolithography process can be used to create this opening 17.

Once the opening 17 is formed so as to penetrate through the first transparent material layer 33 and the second transparent material layer 34, the passivation film 38 is exposed through this opening 17. The passivation film 38 exposed through the opening 17 is then removed. Dry etching using CF₄+O₂ gas or SF₆+O₂ gas can be used to remove the passivation film 38. Once the passivation film 38 exposed through the opening 17 is removed, the opening 17 is formed in the passivation film 38. As a result, the opening 17 penetrating through the first transparent material layer 33, the second transparent material layer 34, and the passivation film 38 is formed. The drain line 16 is now exposed through this opening 17.

Next, as shown in FIG. 7 (b), the pixel electrode 15 is formed on the upper surface of the second transparent material layer 34. For example, ITO (Indium Tin Oxide) with an approximate thickness of 100 nm can be used for the pixel electrode 15. Various known sputtering methods can be used to form the pixel electrode 15. Thereafter, a protective film 35 is formed over the second transparent material layer 34 and the pixel electrode 15 (see FIG. 2).

The display panel substrate 1 of a preferred embodiment of the present invention is manufactured by the steps described above.

Next, a manufacturing method for the display panel 6 of a preferred embodiment of the present invention is described as follows. The manufacturing method for the display panel 6 of a preferred embodiment of the present invention includes the steps of manufacturing a TFT alley substrate, the steps of manufacturing the opposite substrate, and the steps of manufacturing a panel (also referred to as a cell manufacturing step). Here, the step of manufacturing a TFT alley substrate has been described above.

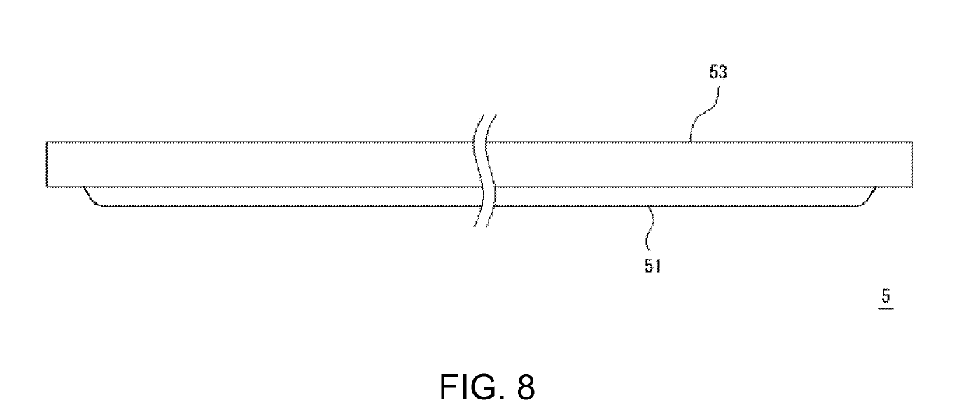

FIG. 8 is a schematic cross-sectional view showing a cross-sectional structure of an opposite substrate 5. As shown in FIG. 8, the opposite substrate 5 has a structure in which common electrode 51 is formed so as to cover almost the entire surface of a transparent substrate 53 except for the outer edges. For example, ITO (Indium Tin Oxide) with an approximate thickness of 100 nm can be used for the common electrode 51, and various known sputtering methods can be used to form the common electrode 51.

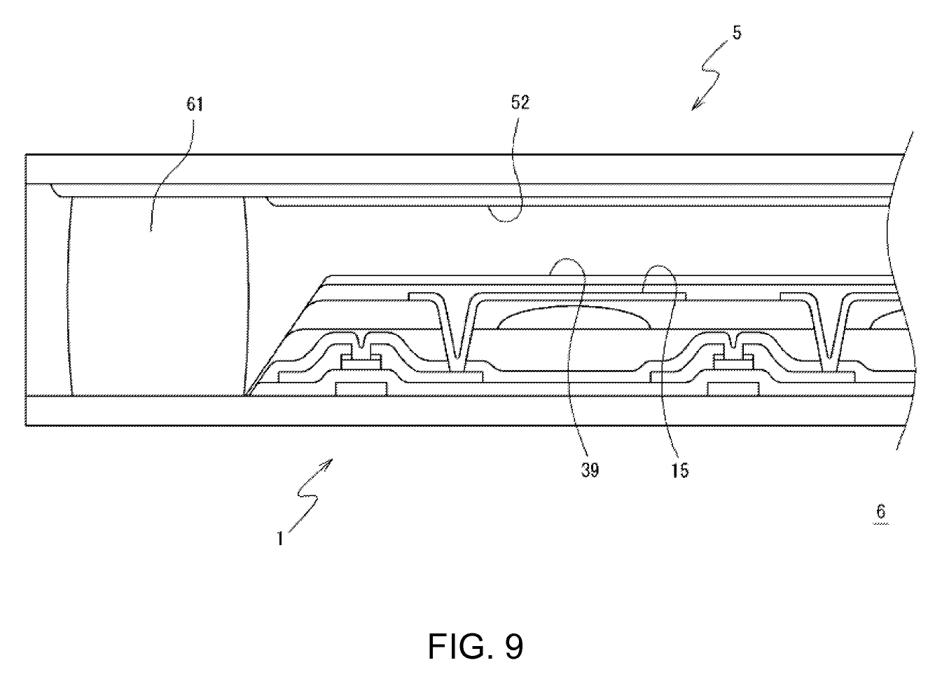

Next, a manufacturing method for a panel is described. FIG. 9 is a schematic cross-sectional view showing a cross-sectional structure of a part of the display panel 6 of a preferred embodiment of the present invention.

An alignment film 39 is formed in the display region on the surface of the display panel substrate 1 of a preferred embodiment of the present invention, which has been manufactured with the aforementioned steps. The display region refers to the area where the pixel electrodes 15 are arranged in a matrix. An alignment film 52 is also formed on the surface of the opposite substrate 5 in the area facing the display region of the display panel substrate 1 of a preferred embodiment of the present invention.

The manufacturing method for the alignment films 39 and 52 is as follows. First, an alignment material is applied to the display panel substrate 1 and to the opposite substrate 5 of preferred embodiments of the present invention by an alignment material applying device or the like. The alignment material refers to a solution containing the substance of which the alignment film 39 and 52 are made (such as polyimide). An ink-jet printing device (a dispenser) can be used as the alignment material applying device. The applied alignment material is then heated and baked by an alignment film baking device or the like. Next, the baked alignment films 39 and 52 are subject to an alignment treatment. Various known treatment methods, such as a method in which minute scratches are applied to the alignment films 39 and 52 by using a rubbing role, or an optical alignment treatment in which light energy such as ultraviolet is irradiated on the alignment films 39 and 52 to adjust the surface texture of the alignment films 39 and 52, can be used for the alignment treatment. A structure without the alignment treatment is also acceptable.

Next, a sealing material 61 is applied to the surface of the display panel substrate 1 of a preferred embodiment of the present invention so as to surround the display region by a seal patterning device or the like.

Then, liquid crystal is delivered by drops onto the area surrounded by the sealing material 61 on the surface of the display panel substrate 1 of a preferred embodiment of the present invention using a liquid crystal dripping device or the like.

Next, the display panel substrate 1 of a preferred embodiment of the present invention and the opposite substrate 5 are bonded in a reduced-pressure atmosphere. Then ultraviolet light is irradiated on the sealing material 61, solidifying the sealing material 61.

The display panel 6 of a preferred embodiment of the present invention is thus obtained by these steps.

As described, the black matrix 36 and the colored layers 21 having the light collecting function are formed on the surface of the substrate 1 on which elements such as the switching elements 14 are formed, not on the opposite substrate 5. Therefore, it is not necessary to form elements on the opposite substrate 5 that requires highly accurate positioning upon bonding the substrates. As a result, the positioning required when the display panel substrate 1 and the opposite substrate 5 are bonded becomes easier, or the positioning with high accuracy becomes unnecessary. Since it is unnecessary to use a device for performing highly accurate positioning when the display panel substrate 1 and the opposite substrate 5 are bonded, the reduction of the equipment cost can be achieved. The production costs of the display panel 6 can also be reduced as the positioning step can be eliminated.

The preferred embodiments of the present invention were described above in detail by referring to the figures, but the present invention is not limited to the aforementioned embodiments, and various modifications and alterations without departing from the scope and spirit of the present invention are apparently possible.

1. A display panel substrate, comprising:
a transparent substrate; and
a plurality of pixel electrodes and switching elements that respectively drive said plurality of pixel electrodes on a one surface of said transparent substrate,
wherein colored layers having a light collecting function are formed between said transparent substrate and said pixel electrodes.

2. The display panel substrate according to claim 1, further comprising a first transparent material layer and a second transparent material layer formed between said transparent substrate and said pixel electrodes in a laminating manner,
wherein said colored layers having the light collecting function are formed between said first transparent material layer and said second transparent material layer.

3. The display panel substrate according to claim 1, further comprising a black matrix formed between said colored layers that are adjacent to each other.

4. The display panel substrate according to claim 1, wherein said colored layer having the light collecting function is formed to have a curved shape in at least one of a surface contacting the first transparent material layer and a surface contacting the second transparent material layer.

5. The display panel substrate according to claim 1, wherein said colored layers having the light collecting function are made of a photosensitive resin material colored in prescribed colors.

6. A display panel substrate comprising:
a transparent substrate;
a plurality of switching elements formed on one surface of said transparent substrate;
bus lines transmitting prescribed signals to said plurality of switching elements;
a first transparent material layer formed to cover said plurality of switching elements and said bus lines;
colored layers having a light collecting function laminated on said first transparent material layer;
a black matrix formed on a surface of said first transparent material layer so as to cover said bus lines;
a second transparent material layer formed to cover said colored layers having the light collecting function and said black matrix; and
a plurality of pixel electrodes formed on a surface of said second transparent material layer, said plurality of pixel electrodes being respectively driven by said switching elements.

7. The display panel substrate according to claim 6, wherein said colored layers having the light collecting function are formed so as to have a curved shape in at least one of a surface contacting the first transparent material layer and a surface contacting the second transparent material layer.

8. The display panel substrate according to claim 6, wherein said colored layers having the light collecting function are made of a photosensitive resin material colored in prescribed colors.

9. A display panel comprising:
the display panel substrate according to claim 1; and an opposite substrate,
wherein said display panel substrate and said opposite substrate are bonded with a certain minute space therebetween, and liquid crystal is filled in between said display panel substrate and said opposite substrate.

10. A method for manufacturing a display panel substrate, comprising:
forming bus lines and switching elements on a one surface of a transparent substrate;
forming a first transparent material layer so as to cover said bus lines and said switching elements;
forming colored layers on a surface of said first transparent material layer;
providing a light collecting function in said colored layers by forming a one surface of said colored layer in a curved shape;
forming a second transparent material layer so as to cover said colored layers; and
forming a plurality of pixel electrodes on a surface of said second transparent material layer.

11. The method for manufacturing the display panel substrate according to claim 10, wherein the step of providing the light collecting function on said colored layers by forming the one surface of said colored layer in a curved shape includes softening said colored layer by heating, and creating the curved surface in said one surface by a surface tension of said softened colored layer.

12. The method for manufacturing the display panel substrate according to claim 10, further comprising forming a black matrix between said colored layers that are adjacent to each other, between the step of providing the light collecting function in said colored layers by forming said one surface of said colored layers in a curved shape and the step of forming the second transparent material layer so as to cover said colored layers.
